(19) United States
(12) Patent Application Publication
(10) Pub. No.: US 2009/0105860 A1
(43) Pub. Date: Apr. 23, 2009

(54) Container Design System, Methods, and Storage Medium Featuring Specific Colors or Indicia

(75) Inventor: Charles Wiesel, Los Angeles, CA (US)

Correspondence Address: HULSEY IP INTELLECTUAL PROPERTY LAWYERS, P.C., 919 Congress Avenue, Suite 919, AUSTIN, TX, 78701, US

(73) Assignee: The Branded Bottle

(21) Appl. No.: 12/021,041

(22) Filed: Jan. 28, 2008

Related U.S. Application Data
(63) Continuation-in-part of application No. 11/874,597, filed on Oct. 18, 2007, now abandoned.

(51) Int. Cl. G06F 19/00

(52) U.S. Cl. 700/97

(57) ABSTRACT

A container design system, method of operation, and storage medium which allows a user(s) to: (1) design a unique complete container including: container size, shape, color, and medium; cap size, shape, color, and medium; label, wherein the label includes one or more specific colors or indicia; what the container will be filled with; and how the containers will be packaged and shipped; and (2) cause the final container to be manufactured, labeled, filled, packaged, and/or shipped according to the user's specific unique parameters; thereby, providing the user a complete container according to the user's particular parameters.

### RELATED APPLICATIONS

This application is a continuation-in-part of and claims priority to U.S. application Ser. No. 11/874,597, by Wiesel, entitled “A Container Design System, Methods of Operation, and Storage Medium”, filed on Oct. 18, 2007, which is incorporated by reference, as if set forth in its entirety herein.

### FIELD OF THE INVENTION

This invention pertains generally to customized consumable beverage containers featuring specific colors or indicia.

### BACKGROUND OF THE INVENTION

Silk screening and labeling of containers are both well known in the art. Silk screening is traditionally done by forming a series of screens. Each screen has a surface were by certain areas of the screen are sealed and others are open such that the picture or text intended to be transferred onto a medium is open. Further, each screen will have different patterns of sealed and open areas for different colors. The screen is placed on top of the medium and ink is applied to the screen. By applying pressure to the ink, the ink is forced through the open areas of the screen and onto the medium. The screen is replaced for subsequent colors. Colors are generally applied in order from lightest to darkest.

Also, directly labeling glass containers through the use of silk screening or labeling a paper label and then attaching the label to a container are both common in the art.

The prior art requires a large quantity of bottles be purchased when a custom label is to be applied or custom container developed. Because of the large quantity required, a custom container is prohibitively expensive to the vast majority of consumers and small businesses. Further, the large quantity requirement does not allow customization of containers for individuals, individual events, celebrations, gifts, party favors, product or service launches, souvenirs, etc. Consequently, the custom container market remains out of reach for the vast majority of consumers who would like to enhance their special event and provide their guests a reminder of the event.

The prior art does not disclose applying a screened image, logo, or custom design directly to a plastic container in any color. The prior art only discloses applying a label to a sleeve which is then attached to the bottle. This adds additional cost, development time, steps, and waste to the development process.

The prior art's design process is time consuming, complicated, frustrating, and prone to error. The prior art requires either professional design consultants or considerable expertise to develop a fully customized and professional container. If professional design consultants are required, the overall cost of the custom container increases substantially. When coupled with smaller quantity orders (ex. under 250), the per container cost of professional design consultants sky rockets. The considerable expertise required without professional design consultants increases the complexity and time associated with designing a custom container. The general consumer is left with three options: overcome a steep learning curve; have a less then professional final container; or hire professional help.

The prior art does not disclose a complete process whereby a person can design a custom container including: container shape, size, material type, and color; cap shape, size, material type, and color; a customized label featuring specific colors and/or indicia; contents; and/or customized packaging and shipping, all through a user friendly interface allowing a consumer, with little or no design experience, to design either a partially or completely custom container.

### BRIEF SUMMARY OF THE INVENTION

There is a need for a process that allows a user to easily design a complete custom container including: container size, color, shape, type, and ornamental design; cap size, shape, color, type, and ornamental design; label; contents; decorations or embellishments packaging; shipping; and featuring specific colors or indicia. For example, a complete custom container for: athletic team or event, stadium, venue, school, political organization or affiliation, concert, flag, governing body (e.g. the National Football League), souvenirs, product or service launch, advertising campaign, promotional materials, etc. As an additional example, the container could promote event sponsorship (e.g. FedEx™ Orange Bowl™), a particular game (e.g. Super Bowl™ between the New York Giants™ and the New England Patriots™), for revenue generation as ad space (e.g. Allstate Insurance™ supports the Baltimore Orioles™), or for interactive event marketing (e.g. the container with number 832 wins a prize). Indicia is intended to include mark, logo, design, symbol, denotation, design, emblem, image, pattern, regalia, sign, stamp, brand, brand name, tag, monogram, rune, badge, insignia, motto, pattern, slogan, crest, flag, pennant, seal, colophon, and the like, associated with a product, service, entity, person, organization, geographic locale, event, or the like.

The disclosed subject matter includes a design process which accepts a user's unique design parameters, which may include container parameters, label parameters, fill parameters, decoration or embellishment parameters, packaging parameters, shipping parameters, and/or specific colors or indicia, and creates the container according to the user's unique design parameters all through a user interface that requires little to no design experience.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the accompanying claims.

### BRIEF DESCRIPTIONS OF THE DRAWINGS

The novel features believed characteristic of the invention are set forth in the claims. The invention itself, however, as well as a preferred mode of use, further objectives, and advantages thereof, will best be understood by reference to the following detailed description of an illustrative embodiment when read in conjunction with the accompanying drawings, wherein:

FIG. 0 illustrates a computer system and related peripherals that may operate with the trivia based game of the present embodiment.

FIGS. 1a, 1b, and 2 depict exemplary pictures of containers featuring specific colors and indicia of the present embodiment.

FIG. 3 depicts a flow chart of the design process of the present embodiment.

FIG. 4 depicts a flow chart of the label design process of the present embodiment.

FIG. 5 depicts a flow chart of the production process of the present embodiment.

FIG. 6 depicts a flow chart of the optional decorations of the present embodiment.

FIG. 7 depicts several examples of pre-forms of the present embodiment.

FIG. 8 depicts several examples of cap top art of the present embodiment.

FIG. 9 shows multiple cross sectional views of the blow molding process of the present embodiment.

### DETAILED DESCRIPTION OF ILLUSTRATIVE EMBODIMENTS

Although described with particular reference to containers made of plastic, the claimed subject matter can be implemented in any medium.

Those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

A technical advantage of the present invention is allowing a user to design a custom label using an uploaded design, a design interface, or engage an in house designer to design the label. The design interface enables the user to either customize a pre-existing template or make a completely custom label design. Further, the label can be screened directly onto the container.

Another technical advantage of the present invention is allowing a user to easily design a completely custom container including container shape, size, color, material type, decoration or embellishment, contents, packaging, and label as well as cap type, cap material, cap color, cap decorations or embellishments, and cap label through a user interface that provides the user a step-by-step process requiring little to no previous experience.

An additional technical advantage of the present invention is allowing a user to provide parameters to differentiate the user's container from other products/containers by label, container material, color, decoration, container design, cap design, contents (artesian water, spring water, sparkling water, purified water, flavored water, juice, carbonated beverage, etc.), and/or packaging while keeping the quantity of containers required relatively low.

Yet another technical advantage of the present invention is allowing a user to design, or have a design company design, a complete container, have the container made, have decorations or embellishments added to the container, have the container filled with a liquid or semi-liquid substance, have the completed containers packaged, and have the containers delivered, all through a single user interface.

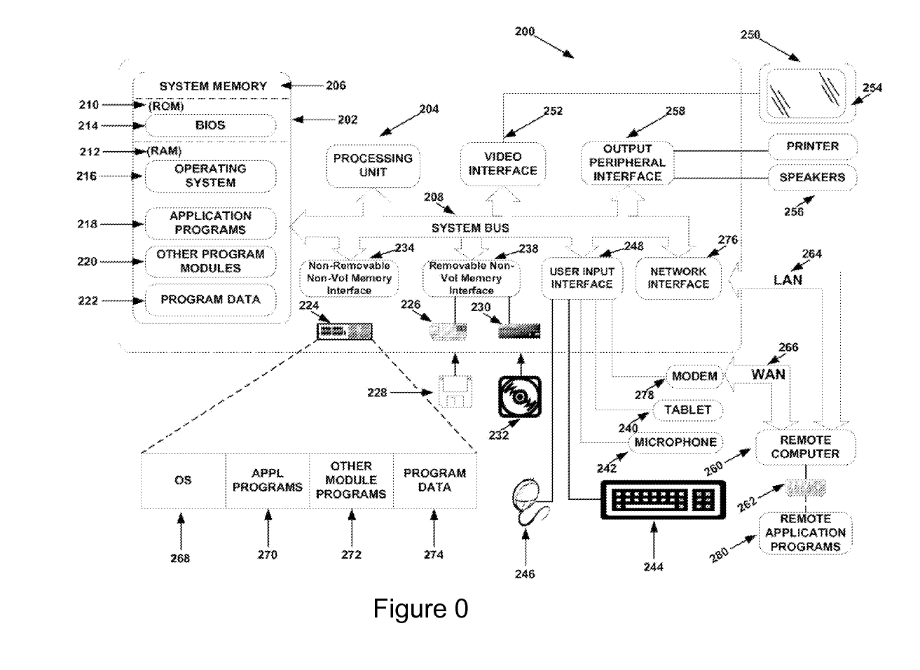

With reference to FIG. 0, an exemplary system within a computing environment for implementing the invention includes a general purpose computing device in the form of a computing system 200, commercially available from Intel, IBM, AMD, Motorola, Cyrix and others. Components of the computing system 202 may include, but are not limited to, a processing unit 204, a system memory 206, and a system bus 236 that couples various system components including the system memory to the processing unit 204. The system bus 236 may be any of several types of bus structures including a memory bus or memory controller, a peripheral bus, and a local bus using any of a variety of bus architectures.

Computing system 200 typically includes a variety of computer readable media. Computer readable media can be any available media that can be accessed by the computing system 200 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 200.

The system memory 206 includes computer storage media in the form of volatile and/or nonvolatile memory such as read only memory (ROM) 210 and random access memory (RAM) 212. A basic input/output system 214 (BIOS), containing the basic routines that help to transfer information between elements within computing system 200, such as during start-up, is typically stored in ROM 210. RAM 212 typically contains data and/or program modules that are immediately accessible to and/or presently being operated on by processing unit 204. By way of example, and not limitation, an operating system 216, application programs 220, other program modules 220 and program data 222 are shown.

Computing system 200 may also include other removable/non-removable, volatile/nonvolatile computer storage media. By way of example only, a hard disk drive 224 that reads from or writes to non-removable, nonvolatile magnetic media, a magnetic disk drive 226 that reads from or writes to a removable, nonvolatile magnetic disk 228, and an optical disk drive 230 that reads from or writes to a removable, nonvolatile optical disk 232 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 224 is typically connected to the system bus 236 through a non-removable memory interface such as interface 234, and magnetic disk drive 226 and optical disk drive 230 are typically connected to the system bus 236 by a removable memory interface, such as interface 238.

The drives and their associated computer storage media, discussed above, provide storage of computer readable instructions, data structures, program modules and other data for the computing system 200. For example, hard disk drive 224 is illustrated as storing operating system 268, application programs 270, other program modules 272 and program data 274. Note that these components can either be the same as or different from operating system 216, application programs 220, other program modules 220, and program data 222. Operating system 268, application programs 270, other program modules 272, and program data 274 are given different numbers hereto illustrates that, at a minimum, they are different copies.

A user may enter commands and information into the computing system 200 through input devices such as a tablet, or electronic digitizer, 240, a microphone 242, a keyboard 244, and pointing device 246, commonly referred to as a mouse, trackball, or touch pad. These and other input devices are often connected to the processing unit 204 through a user input interface 248 that is coupled to the system bus 208, but may be connected by other interface and bus structures, such as a parallel port, game port or a universal serial bus (USB).

A monitor 250 or other type of display device is also connected to the system bus 208 via an interface, such as a video interface 252. The monitor 250 may also be integrated with a touch-screen panel or the like. Note that the monitor and/or touch screen panel can be physically coupled to a housing in which the computing system 200 is incorporated, such as in a tablet-type personal computer. In addition, computers such as the computing system 200 may also include other peripheral output devices such as speakers 254 and printer 256, which may be connected through an output peripheral interface 258 or the like.

Computing system 200 may operate in a networked environment using logical connections to one or more remote computers, such as a remote computing system 260. The remote computing system 260 may be a personal computer, a server, a router, a network PC, a peer device or other common network node, and typically includes many or all of the elements described above relative to the computing system 200, although only a memory storage device 262 has been illustrated. The logical connections depicted include a local area network (LAN) 264 connecting through network interface 276 and a wide area network (WAN) 266 connecting via modem 278, but may also include other networks. Such networking environments are commonplace in offices, enterprise-wide computer networks, intranets and the Internet.

For example, in the present embodiment, the computer system 200 may comprise the source machine from which data is being migrated, and the remote computing system 260 may comprise the destination machine. Note however that source and destination machines need not be connected by a network or any other means, but instead, data may be migrated via any media capable of being written by the source platform and read by the destination platform or platforms.

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

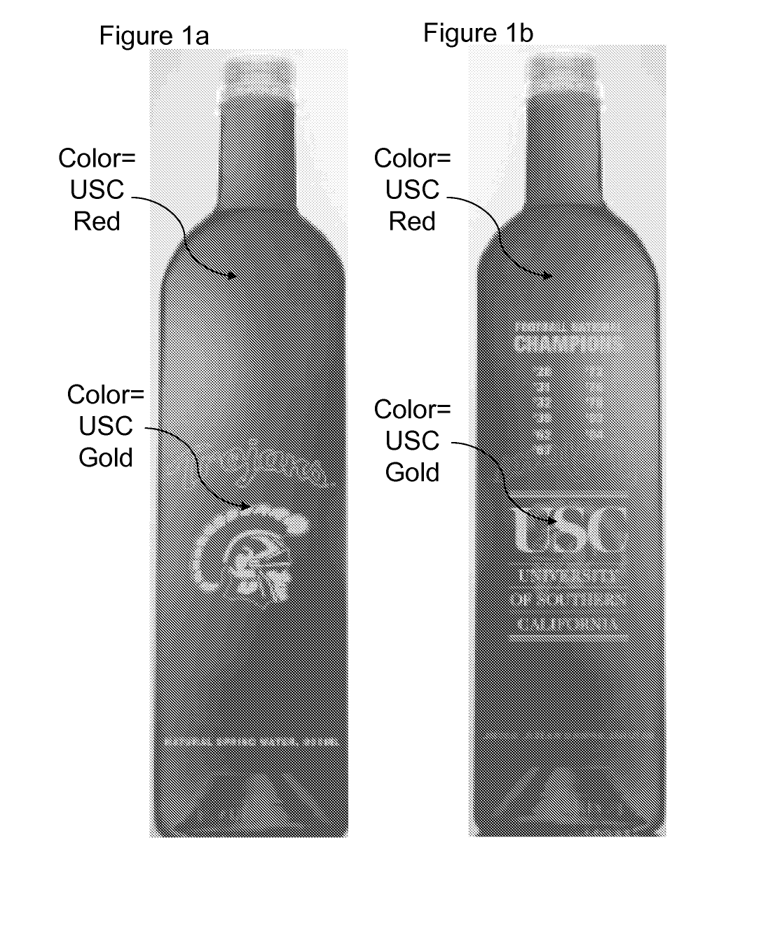

FIGS. 1a, 1b, and 2 depict exemplary pictures of a container featuring specific colors and indicia of the present embodiment. FIGS. 1a and 1b, respectively, depict the front and back of an exemplary container with a college football indicia. Specifically, the front has the stylized name of the school's mascot and an image of the mascot. The back identifies the school and commemorates the school's national football championships. The entire container is in the specific colors associated with the college football team. FIG. 2, depicts an additional exemplary container commemorating a professional baseball team's 50^{th} anniversary. Specifically, FIG. 2 shows an indicia corresponding to the baseball team's official 50^{th} anniversary logo and is in the specific colors associated with the baseball team and the 50^{th} anniversary.

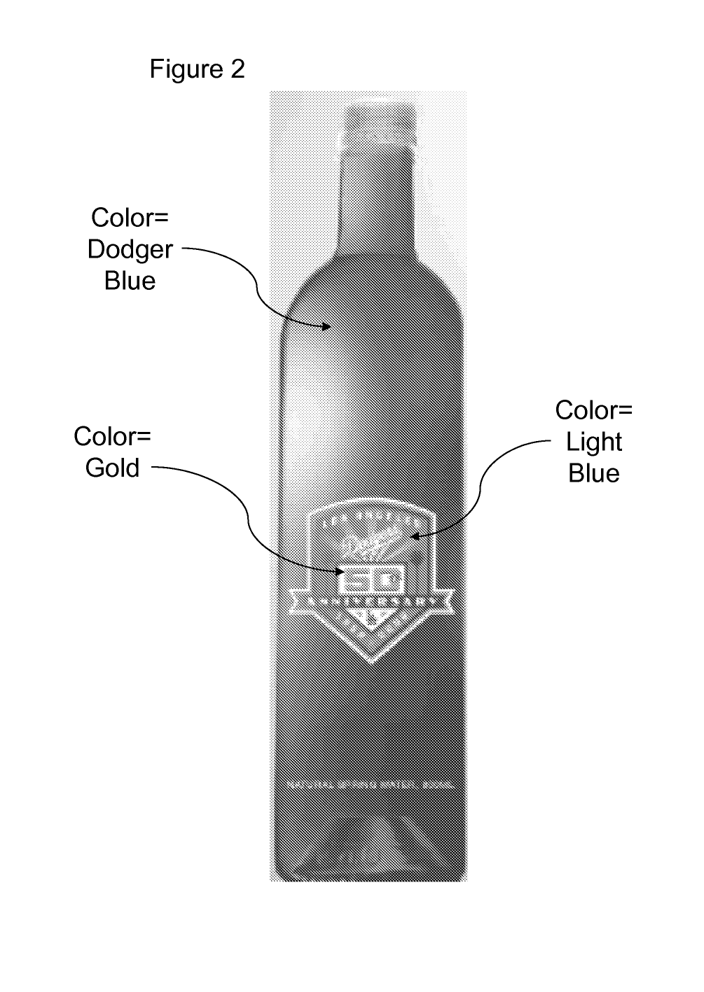

FIG. 3 depicts a flow chart of the design process 300 of the present embodiment. First, the user connects to the design process 300. In one embodiment the user could connect to the design process 300 via a communication network such as the Internet. In another embodiment, the user could download software containing the design process 300. In yet another embodiment, the user could contact an operator or other party to connect to the design process 300. Regardless of the method of connecting to the design process 300, the container parameters are inputted. In one embodiment, a user could first select the size of the desired container 302. Next, the user could select the shape of the container 304 from a “stock” list or custom design a container. If the user elected to custom design a container, the user could provide all of the necessary container parameters (dimensions, shape, thickness, material, opening dimensions, etc.), a picture of the logo/design, or general guidance as to the design (a particular animal, shape, letter, etc.) and engage an in house designer to provide the necessary container parameters. For example, a user could desire a bottle in the shape of a particular logo and could either provide all of the necessary container parameters or a picture of the logo and an in house designer could provide the specific container parameters. Then the user could select a color for the container 306. Next, the user could select the cap type 308. For example, the cap could be plastic, metal, or some other material. Similar to the container shape, the cap could also be selected from a “stock” list or custom designed. Then the user could select a cap color 310. Finally, the user would proceed to the label design process 312. The colors referenced herein could be any Pantone® color. Though discussed in a specific order, this disclosure is intended to encompass the before mentioned steps in any order.

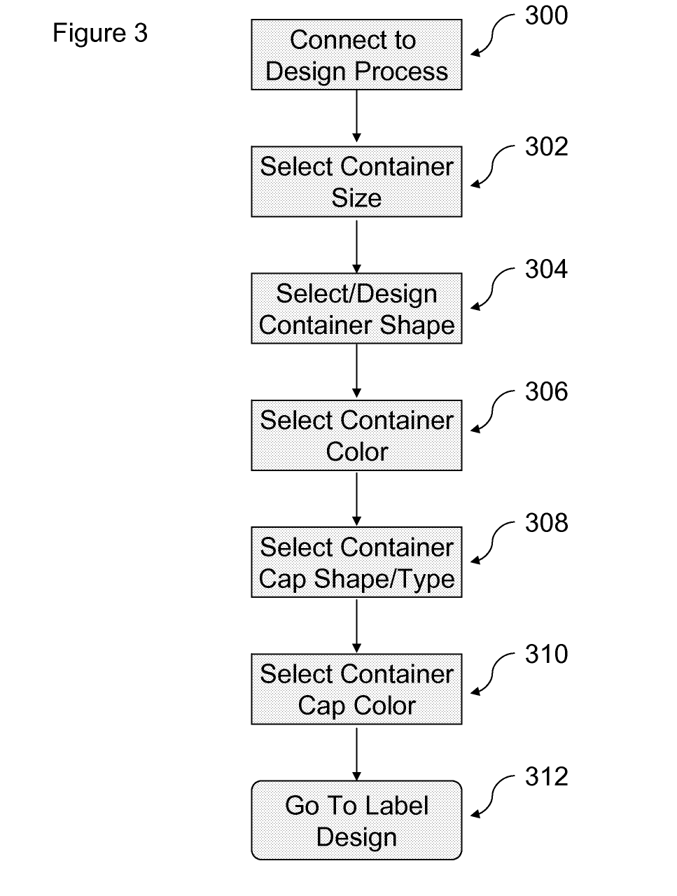

FIG. 4 depicts a flow chart of the label design process 312 of the present embodiment. The user may choose between different label design options including custom in house design 216, user designed through the user design interface 324, and/or upload the user's pre-made design through the upload design 322 interface. The custom in house design 320 option is basically full service design assistance for the user. The custom in house design 320 will discuss the user's desired product, image, and general concept of the label and then produce one or more labels for the user. If more than one design is made or requested, the user can then pick the label design that best fits the user's personal or corporate image and best delivers the user's message. The custom in house design 320 is a full service solution for users desiring a truly professional look or for users that lack the necessary skills or desire to craft a professional look without assistance. The upload design 322 is for users that have already designed a preferred label either with another design company or on the user's own. The upload design 322 interface will allow the user, after making a connection with the design process (see discussion in FIG. 3), the ability to submit their label design. The user may be given several different options as to design formats such as: Adobe Photoshop®, Adobe Illustrator®, Adobe Acrobat®, Adobe Pagemaker®, Freehand®, Quark XPress®, InDesign®, Corel Draw®, Corel PhotoPaint®, encapsulates postscript format (EPS), tag image file format (TIFF), bitmap format (BMP), joint photographic experts group format (JPEG), graphic interchange format (GIF), etc.

The user design interface 324 option provides the user with several options to assist in the design of the label. These options could include: using a pre-defined template 326 or custom designing a label 336. If the user elects to use a pre-defined template 326, the user would be given the option of selecting from several different pre-made templates 328. After selecting the desired template 328, the user would select and position any text on the template 330. This could include selecting font style, size, color, and/or other aspects as well as positioning the text within the template. Next, the user could select and/or position any graphics 332. This could include selecting graphics, changing the size, color, or other aspects of the graphics from pre-made choices, uploading graphics the user already has or already made, or any combination thereof. Finally, the user would proof the final design 342. If the user elected to custom design 336 the label, the user would start with a blank “canvas” and select, position, and/or upload any desired text 338. This could include selecting font style, size, color, and/or other aspects, uploading text, and/or positioning the text. Next, the user would select, position, and/or upload any desired graphics 340. This could include selecting graphics, changing the size, color, or other aspects of the graphics from pre-made choices, uploading graphics the user already has or already made, or any combination thereof. Finally, the user would proof the final design 342. The finally designed label could then be screened directly onto the “stock” container and/or the custom designed container. Throughout the label design process 312 the user could select from several of the specific colors or indicia available. For example, a user could select the colors of a favorite sports team (e.g. silver and blue for the Dallas Cowboys™, burgundy and gold for the Washington Redskins™, etc.), the logo or indicia of a specific event (e.g. the PGA Tour™ logo, the Championships at Wimbledon™ logo, etc.), or the logo or indicia of a political party (e.g. the elephant for the Republican party, the donkey for the Democratic party, etc).

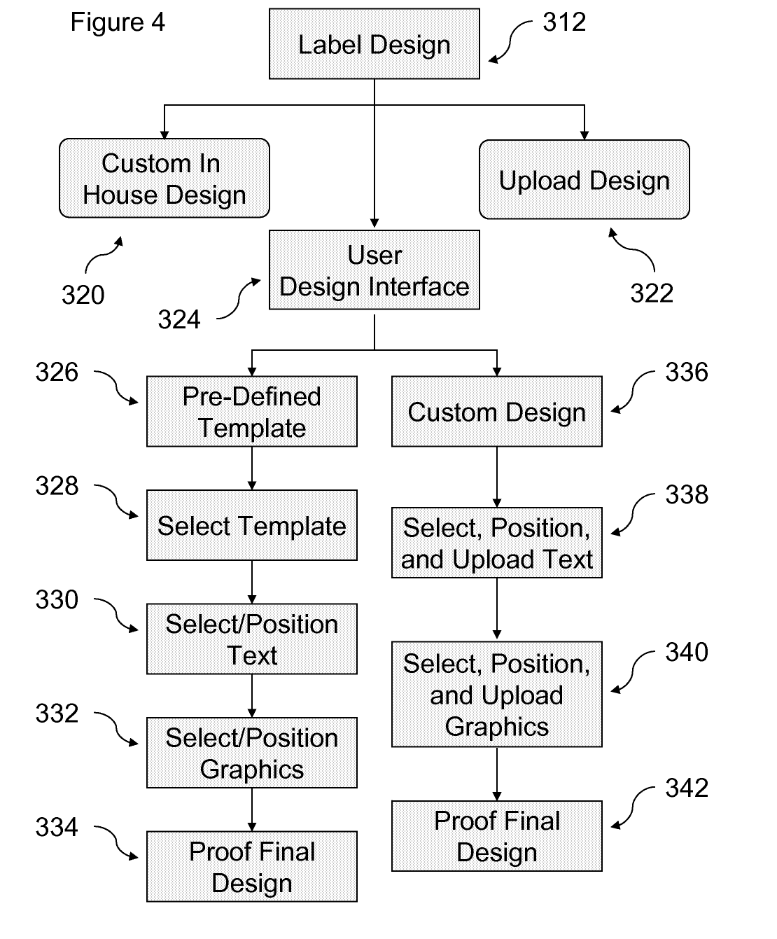

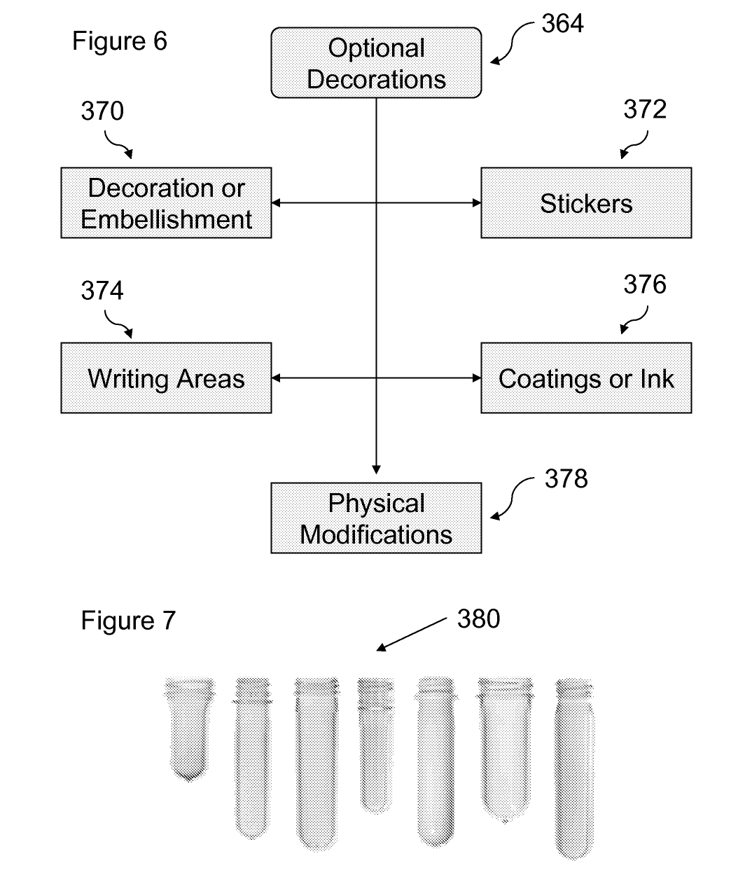

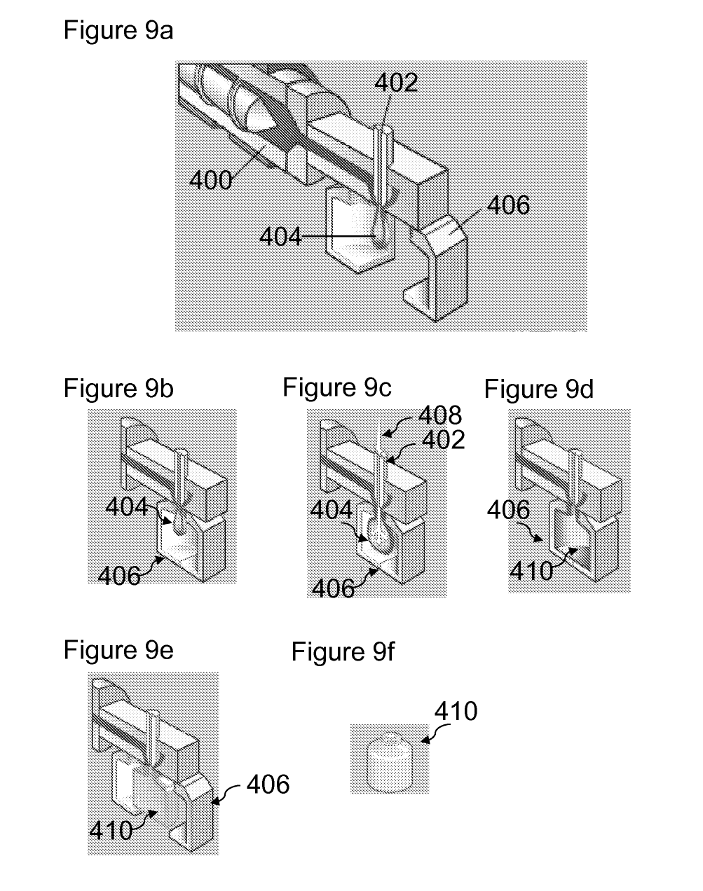

FIG. 5 depicts a flow chart of the production process of the present embodiment. The production process 350 begins by creating a pre-form 352 based on the user's container parameters. Pre-forms are miniature containers around the size of a small test tube (see FIG. 7). The pre-forms are blow molded 354 into the final container shape, size, and design. The blow molding consists of heating the pre-form, inserting the pre-from into a mold, and then blowing the pre-form into the final shape. The mold determines the final shape of the container and is created according to the container parameters (provided by a user, in house designer, or corresponding to the container chosen from the “stock” list). The mold will have the shape of the final container such that when the pre-form expands, the pre-form will conform to the shape of the mold. For each new shape, a new mold must be made. After the pre-form has set (cooled to a sufficient temperature to retain the shape of the mold) the container(s) are screened 356 with the user designed label (see FIG. 4 for further explanation on screening; see also FIG. 9). Once the container's label has dried, the container is rinsed and sterilized 358. The container is then filled 360 according to the user's fill parameters. The container could be filled with any liquid or semi-liquid substance. As a way of illustration, and not limitation, liquid or semi-liquid substance is intended to include: water (purified, spring, sparkling, artesian, flavored, etc.), fruit juices and extracts, liquid tea, liquid coffee, food coloring, milk, vegetable juices and extracts, alcohol, carbonated beverage, etc. In addition, the fill parameters could include any color or flavoring additions and/or alterations. Finally, the containers are packaged 362 for delivery according to the user's instructions. At any time throughout the production process 350 optional decorations 364 may be added to the interior or exterior of the container.

The user could differentiate particular containers through different: container shape, size, color, material, decorations or embellishments, etc.; cap shape, size, color, material, decorations or embellishments, etc.; fill substance; label design; and/or packaging. For example, in a home or office delivery environment it is possible to satisfy each user's desire for specific personalized container and/or types of liquid or semi-liquid substance (artesian water, flavored water, spring water, sparkling water, juice, etc.) available for particular people, employees, or clients by altering the type of liquid or semi-liquid substance, parameters of the container (color, shape, size, material, decorations or embellishments, etc.), altering the parameters of the cap (color, shape, material, decorations or embellishments, etc.), changing the color of the liquid or semi-liquid substance, adding names or other indications on the container or label, or adding decorations or embellishments to the container or label. As an additional illustration, a user could have a red container for artesian water, blue container for sparkling water, and/or a green container for purified water. Further, the user could differentiate particular containers for home or office delivery (ex. have different colors reference different water types at home than at the office).

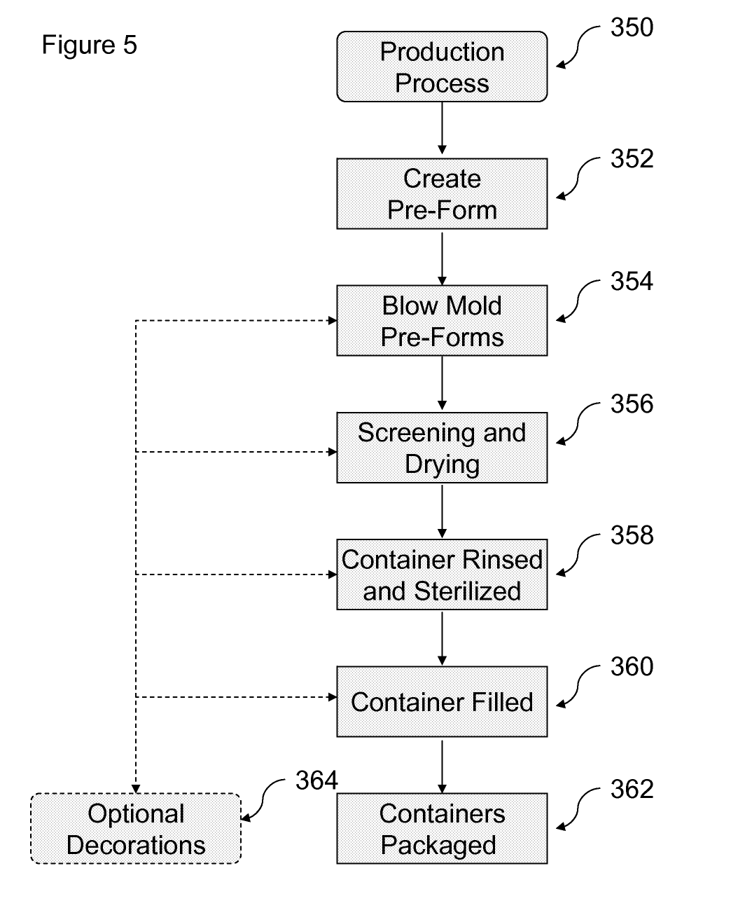

FIG. 6 depicts a flow chart of the optional decorations of the present embodiment. Some of the optional decorations 364 could include decoration or embellishments 370, stickers 372, areas for writing 374, coatings or ink that have altered aspects based on temperature or light 376, physical modifications to the container or cap 378, etc. For example, to change the outside physical aspects of a particular container, the mold could be bead blasted such that when the pre-forms are blow molded (see 354 on FIG. 5) the resulting container has distortions on the surface from the distortions on the walls of the mold. This type of bead blasting could give the resulting container a frosted look and feel. In another example, after the pre-form is blow molded (see 354 on FIG. 5), the resulting container could be sandblasted to create a rough appearance and feel. This sandblasting could take place anytime after the pre-forms are blow molded (see 354 on FIG. 5). The sandblasting could be done before the screening and drying (see 356 on FIG. 5) such that the label is applied over the rough texture. In an additional example, the sandblasting could be done after the screening and drying (see 356 on FIG. 5) such that the label itself is sandblasted creating a different visual and physical texture for the label. Yet another example would be to apply a coating on a container (either before or after screening and drying 246) that would give the container an alternate frosted look.

FIG. 7 shows examples of several pre-forms 380. As discussed previously, the pre-forms 380 resemble small test tubes. The pre-forms 380 come in a variety of colors, sizes, and materials such that the user's design will be implemented. For example, the pre-form would have to be larger for a 48 oz. container than a 12 oz. container of the same thickness.

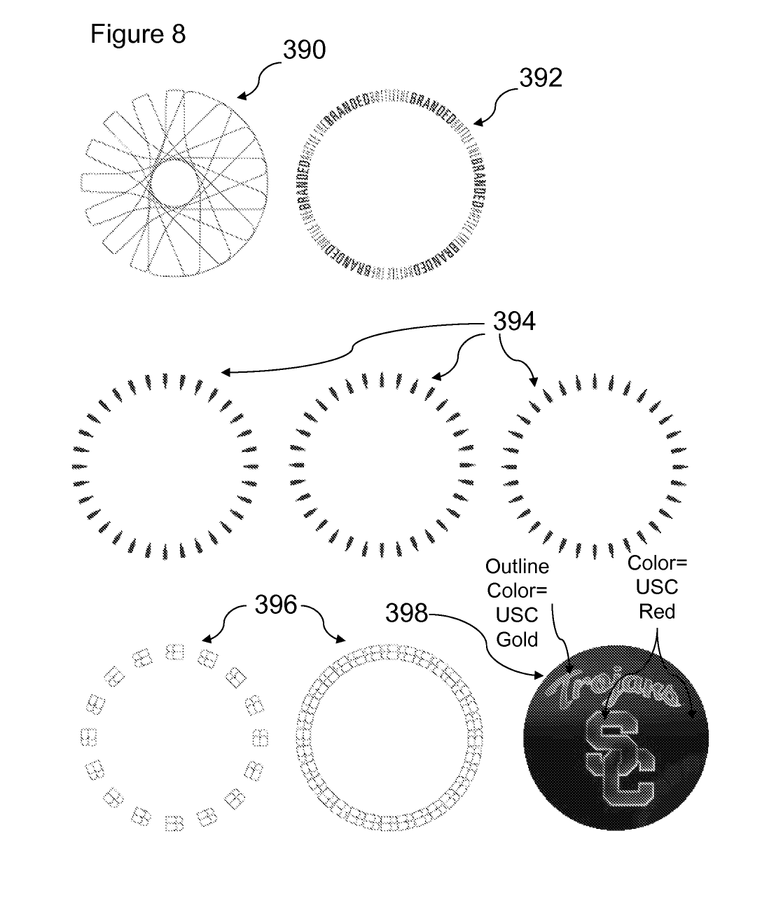

FIG. 8 shows several examples of cap decorations. The cap decorations could be a reoccurring object such as a bottle 390, a logo or word 392, a design 394, other graphic 396, or a specific color with or without a corresponding indicia 398. For example, a user could select the colors of a favorite sports team (e.g. silver and blue for the Dallas Cowboys™, burgundy and gold for the Washington Redskins™, etc.), the logo or indicia of a specific event (e.g. the PGA Tour™ logo, the Championships at Wimbledon™ logo, etc.), or the logo or indicia of a political party (e.g. the elephant for the Republican party, the donkey for the Democratic party, etc).

FIG. 9 shows multiple cross sectional views of the blow molding process of the present embodiment. Referring to FIG. 9a, an extruder 400 pushes a molten compound (normally a polymer) 404 through an opening in the top of the split mold 406. There is a blow pin 402 to assist in expanding the molten compound 404 into the split mold 406 (see FIG. 9c). FIG. 9b shows the molten compound 404 being injected into the split mold 406 after the split mold 406 has been closed. FIG. 9c shows air 408 being injected into the blow pin 402. This air 408 injection forces the molten compound 404 to expand into the split mold 406 such that once the molten compound 404 cools, the resulting container 410 (not shown) will retain the shape of the split mold 406. FIG. 9d shows the split mold 406 with a formed container 410 inside. After the container 410 has cooled to the point that it will retain its shape, the split mold 406 is opened as depicted in FIG. 9e. Finally, FIG. 9f shows the final container 410 after being removed from the split mold 406 (not shown).

As a way of illustration, and not of limitation, the present invention could be used for promotions, collectibles, advertising, marketing, customer appreciation, novelties, prizes, charity events, fund raisers, etc. by non-profit companies, private and public companies, individuals, small groups, organizations, etc

In addition to the above described embodiments, each is intended to include variants for other design options such as: adding three dimensional decorations (e.g. eyes, golf balls, hats, jewels, crystals, buttons, clips, stars, flowers, seasonal items, beads, ribbon, bows, string, etc.); stickers and/or scratchable items (instant win tickets, scratch and win tickets, etc.); blank area suitable for user writing or user sticker attachment; ink and/or decorations that change color or form based on the internal and/or external temperature; ink and/or decorations that change color or form based on the brightness, amount, or type of light (ultraviolet, infrared, black); applying coatings to adjust the visual aspects of the container (frost coating to simulate a cold bottle, pebbled coating to simulate a rough bottle, simulating condensation, coating that changes color or other characteristic based on internal and/or external temperature, coating that changes color or other characteristic based on brightness, amount, or type of light, etc.); physically modifying the container to adjust the visual and/or physical aspects (sand blasting, shallow cuts, etching, burning, sanding, etc.); and different container materials (plastics, glasses, metals, etc.). In addition, to the above described embodiments, each is intended to include other variants of specific colors and indicia such as: venues, athletic teams, athletic events, governing bodies, licensing bodies, flags, tours, concerts, concert tours, national tours, international tours, political events, political affiliations, political organizations, schools, social organizations, fundraising, trademarks, service marks, trade names, certification marks, collective trademarks, collective membership marks, domain names, and other events, names, colors, and logos. Further, the specific colors or indicia can be for any sport and show any team allegiance or support, regardless of level of competition. Thus, the invention is useful for elementary school, middle school, junior high school, high school, college, and professional sports indicia for all sports. It should also be understood that the specific colors and indicia are not limited to sports teams and organizations, but could include any color(s) or indicia for which support or association may be expressed.

What is claimed is:

1. A system for creating a container according to a user's parameters, the system comprising:
an ordering component that accepts a user's specific parameters, the user's specific parameters including:
container parameters; and
label parameters, wherein said label parameters includes one or more specific colors or indicia; and
a manufacturing component that creates a uniquely tailored final container according to the user's specific parameters, the manufacturing component includes:
creating a container according to the container parameters; and
labeling the container according to the label parameters.

2. The system of claim 1, wherein:
the user's specific parameters also include:
fill parameters; and
cap parameters; and
the manufacturing component includes:
filling the container according to the fill parameters; and
creating a cap according to the cap parameters.

3. The system of claim 2, wherein at least one of the user's specific parameters is unique to the user.

4. The system of claim 3, wherein:
the user's specific parameters also includes decoration or embellishment parameters; and
the manufacturing component includes applying a decoration or embellishment to the container according to the decoration or embellishment parameters.

5. The system of claim 4, wherein:
the user's specific parameters also includes packaging parameters; and
the manufacturing component includes packaging at least one final container according to the packaging parameters.

6. The system of claim 5, wherein:
the user's specific parameters also includes shipping parameters; and
the manufacturing component includes shipping at least one packaged container according to the shipping parameters.

7. The system of claim 2, wherein said cap parameters includes one or more specific colors or indicia.

8. The system of claim 1, wherein the labeling of the final container is accomplished by screening a label directly onto the final container.

9. The system of claim 1, wherein the user's specific parameters are communicated via the Internet.

10. A method of creating a complete container according to a user's parameters, the method comprising the steps of:
accepting a user's specific parameters, the user's specific parameters including:
container parameters; and
label parameters, wherein said label parameters includes one or more specific colors or indicia; and
manufacturing a uniquely tailored final container according to the user's specific parameters, the manufacturing step including:
creating a container according to the container parameters; and
labeling the container according to the label parameters.

11. The method of claim 10, wherein:
the user's specific parameters also include:
fill parameters; and
cap parameters; and
the manufacturing step also includes:
filling the container according to the fill parameters; and
creating a cap according to the cap parameters.

12. The method of claim 11, wherein at least one of the user's specific parameters is unique to the user.

13. The method of claim 12, wherein:
the user's specific parameters also includes decoration or embellishment parameters; and
the manufacturing step includes applying a decoration or embellishment to the container according to the decoration or embellishment parameters.

14. The method of claim 13, wherein:
the user's specific parameters also includes packaging parameters; and
the manufacturing step includes packaging at least one final container according to the packaging parameters.

15. The method of claim 14, wherein:
the user's specific parameters also includes shipping parameters; and
the manufacturing step includes shipping at least one packaged container according to the shipping parameters.

16. The method of claim 10, wherein said cap parameters includes one or more specific colors or indicia.

17. The method of claim 9, wherein labeling the container is accomplished by screening a label directly onto the container.

18. The method of claim 9, wherein the user's specific parameters are communicated via the Internet.

19. A computer readable medium encoded with a program for creating a complete container according to a user's parameters, the program comprising the steps of:
accepting a user's specific parameters, the user's specific parameters including:
container parameters; and
label parameters, wherein said label parameters includes one or more specific colors or indicia; and
manufacturing a uniquely tailored final container according to the user's specific parameters, the manufacturing step including:
creating a container according to the container parameters; and
labeling the container according to the label parameters.

20. The medium of claim 19, wherein:
the user's specific parameters also include:
fill parameters; and
cap parameters; and
the manufacturing step also includes:
filling the container according to the fill parameters; and
creating a cap according to the cap parameters.

21. The medium of claim 20, wherein at least one of the user's specific parameters is unique to the user.

22. The medium of claim 21, wherein:
the user's specific parameters also includes:
decoration or embellishment parameters;
packaging parameters; and
shipping parameters; and
the manufacturing step includes:
applying a decoration or embellishment to the container according to the decoration or embellishment parameters;
packaging at least one final container according to the packaging parameters; and
shipping at least one packaged container according to the shipping parameters.

23. The medium of claim 20, wherein said cap parameters includes one or more specific colors or indicia

24. The medium of claim 19, wherein labeling the container is accomplished by screening a label directly onto the container.

25. The medium of claim 19, wherein the user's specific parameters are communicated via the Internet.
